(19) United States
(12) Patent Application Publication
(10) Pub. No.: US 2013/0112904 A1
(43) Pub. Date: May 9, 2013

(54) SOLENOID VALVE WITH A TWO-PART CORE

(71) Applicant: Vincent Tanari, Geneve (CH)

(72) Inventor: Vincent Tanari, Geneve (CH)

(73) Assignee: FLUID AUTOMATION SYSTEMS S.A., Versoix (CH)

(21) Appl. No.: 13/809,680

(22) PCT Filed: Jul. 19, 2011
(86) PCT No.: PCT/EP2011/062395

§ 371 Date: Jan. 11, 2013

Related U.S. Application Data
(60) Provisional application No. 61/370,890, filed on Aug. 5, 2010.

(51) Int. Cl. H01F 3/00; F16K 99/00; F16K 31/06

(52) U.S. Cl. CPC H01F 3/00; F16K 31/0675; F16K 99/00
USPC 251/129.15; 137/15.18; 335/297

(57) ABSTRACT

A magnetic core (210) for a solenoid valve is provided. The magnetic (210) includes a first part (210a) defining a cavity (213). The first part (210a) is formed from a first material having a first magnetic performance. The magnetic core (210) also includes a second part (210b) positioned at least partially within the cavity (213). The second part (210b) is formed from a second material having a second magnetic performance that is higher than the first magnetic performance.

### TECHNICAL FIELD

The present invention relates to, solenoid valves, and more particularly, to a solenoid valve with a two-part core.

### BACKGROUND OF THE INVENTION

Fluid control valves are used in a wide variety of applications to control the flow of a fluid. The fluid being controlled may comprise a gas, a liquid, or a combination thereof. In some situations, the fluid may also include suspended particulates. While fluid control valves vary widely in the specific configuration used to open and close a fluid communication path through the valve, one specific type of valve actuation is performed using a solenoid. In solenoid-actuated valves, the solenoid comprises an electric current that passes through an electromagnetic coil, with the coil typically formed around a magnetic core. The energized solenoid generates a magnetic field. The magnetic field operates on a movable armature connected to a valve member. Typically, the valve also includes a spring or other biasing member that generates a biasing force in opposition to the magnetic field. Therefore, in the absence of a magnetic field generated by the solenoid, the valve member is moved into a normally open or a normally closed position.

Solenoid-actuated valves have several advantages. Solenoid actuated valves can accommodate varying flow rates. Solenoid-actuated valves can form a highly reliable seal, even in the presence of moisture, dirt, debris, etc. Due to the benefits that solenoid-actuated valves provide, they are very popular for industrial applications. However, solenoid valves can experience difficulties in high flow rate environments. This is because for a valve to perform with high flow and high pressure, the stroke of the valve must increase. The increased stroke requires more magnetic force and thus, for a given input power, a better magnetic circuit is required. Generally, the magnetic flux is limited for a given solenoid valve based on the magnetic performance of the magnetic core used to direct the magnetic flux. The magnetic core is often formed from a material having a limited magnetic performance in order to maintain a corrosion resistant valve.

FIG. 1 shows a cross-sectional view of a prior art solenoid valve 100. The prior art solenoid valve 100 includes a housing 101, a first fluid port 102, a second fluid port 103, a fluid nozzle 104, a fluid chamber 105, a valve member 106, and a valve seat 107. The solenoid valve 100 also includes an electromagnetic coil 108 located in a sleeve 109. Positioned within the coil 108 is a magnetic core 110. The magnetic core 110 may be formed from a material that is magnetically permeable, while also exhibiting corrosion resistance. An example of such a material is ferritic stainless steel. The magnetic core 110 is typically provided to direct and focus the magnetic flux produced by the coil 108. The solenoid valve 100 also includes a movable armature 111. As can be appreciated, as the electromagnetic coil 108 is energized as is known in the art, a magnetic flux is created through the magnetic core 110 thereby biasing the movable armature 111 and the valve member 106 in either a first direction or a second direction. The valve 100 is further shown with a biasing member 112. The biasing member 112 comprises a plate spring that provides a biasing force that is substantially opposite the biasing force provided by the energized coil 108.

The movable armature 111 can be coupled to the valve member 106. The valve member 106 therefore moves in response to the biasing member 112 or the magnetic flux along with the movable armature 111 in order to either open a fluid flow path between the inlet and outlet ports 102, 103 or seal against the valve seat 107 to close the fluid flow path between the inlet and outlet ports 102, 103.

While the prior art solenoid valve 100 operates satisfactorily when the valve is subjected to relatively low flow rates and/or fluid pressures, the valve 100 begins to suffer as the flow rate increases. As mentioned above, this is because a stronger biasing member 112 is required in order to properly close the valve 100. Therefore, a stronger magnetic flux is required in order to overcome the biasing force provided by the biasing member 112. With a magnetic core 110 formed from ferritic stainless steel, the magnetic flux is relatively limited due to the insufficient magnetic performance. However, due to potential fluid contact with the magnetic core 110, a material having a high corrosion resistance is required. Because there is no material currently available that can increase the attraction force while maintaining sufficient corrosion resistance, the prior art valve 100 sacrifices magnetic performance in order to provide a corrosion resistant magnetic core 110.

Typically, an increased magnetic flux is achieved in one of two ways. A first solution is to increase the size of the electromagnetic coil. This has the drawback of increasing the overall size of the valve, which may not be desirable in many situations. A second solution is to increase the current supplied to the electromagnetic coil. However, this solution increases the heat generated by the valve as well as the energy required to operate the valve, neither of which is desirable.

The present invention overcomes these and other problems and an advance in the art is achieved. The present invention provides a solenoid valve including a two-part magnetic core, with the two parts being formed from different materials. The first part is formed from a material having a low magnetic performance, but a high corrosion resistance. The material used to form the first part may also have better mechanical properties and/or lower cost. The second part is inserted at least partially into a cavity formed by the first part. The second part is formed from a material having a higher magnetic performance, but a lower corrosion resistance compared to the material used to form the first part. The second material may also have less desirable mechanical characteristics. For example, the second material may be more difficult to manufacture into complex shapes.

### SUMMARY OF THE INVENTION

A magnetic core for a solenoid valve is provided according to an embodiment of the invention. The magnetic core comprises a first part defining a cavity. According to an embodiment of the invention, the first part is formed from a first material having a first magnetic performance. According to an embodiment of the invention, the magnetic core further includes a second part positioned at least partially within the cavity. The second part can be formed from a second material having a second magnetic performance that is higher than the first magnetic performance.

A solenoid valve is provided according to an embodiment of the invention. The solenoid valve comprises an inlet port and an outlet port. The solenoid valve further comprises a valve member selectively providing fluid communication between the inlet port and the outlet port and an electromagnetic coil providing a biasing force on the valve member when energized. According to an embodiment of the invention, the solenoid valve further comprises a magnetic core positioned within the electromagnetic coil. The magnetic core includes a first part defining a cavity, which is formed from a first material having a first magnetic performance. The magnetic core further comprises a second part positioned at least partially within the cavity, which is formed from a second material having a second magnetic performance that is higher than the first magnetic performance.

A method for forming a solenoid valve including an inlet port, an outlet port, and a valve member selectively providing fluid communication between the inlet port and the outlet port is provided according to an embodiment of the invention. The method comprises a step of positioning an electromagnetic coil proximate the valve member to provide a biasing force on the valve member when energized. The method further comprises a step of positioning a first part of a magnetic core within the electromagnetic coil, wherein the first part is formed from a first material having a first magnetic performance. According to an embodiment of the invention, the method further comprises steps of defining a cavity with the first part and positioning a second part of the magnetic core at least partially within the cavity, wherein the second part is formed from a material having a second magnetic performance that is higher than the first magnetic performance.

### Aspects

According to an aspect of the invention, a magnetic core for a solenoid valve comprises:
a first part defining a cavity and being formed from a first material having a first magnetic performance; and
a second part positioned at least partially within the cavity and being formed from a second material having a second magnetic performance that is higher than the first magnetic performance.

Preferably, the first material further comprises a first corrosion resistance and wherein the second material comprises a second corrosion resistance that is less than the first corrosion resistance.

Preferably, the first material comprises ferritic stainless steel.

Preferably, the second material comprises soft iron.

According to another aspect of the invention, a solenoid valve comprises:
an inlet port;
an outlet port;
a valve member selectively providing fluid communication between the inlet port and the outlet port;
an electromagnetic coil providing a biasing force on the valve member when energized;
a magnetic core positioned within the electromagnetic coil and including:
   a first part defining a cavity and being formed from a first material having a first magnetic performance; and
   a second part positioned at least partially within the cavity and being formed from a second material having a second magnetic performance that is higher than the first magnetic performance.

Preferably, the first material further comprises a first corrosion resistance and wherein the second material comprises a second corrosion resistance that is less than the first corrosion resistance.

Preferably, the solenoid valve further comprises a movable armature coupled to the valve member.

Preferably, the movable armature is positioned at least partially within the electromagnetic coil.

Preferably, the first part of the magnetic core isolates the second part from the inlet and outlet ports.

Preferably, the first material comprises ferritic stainless steel.

Preferably, the second material comprises soft iron.

According to another aspect of the invention, a method for forming a solenoid valve including an inlet port, an outlet port, and a valve member selectively providing fluid communication between the inlet port and the outlet port comprises steps of:
positioning an electromagnetic coil proximate the valve member to provide a biasing force on the valve member when energized;
positioning a first part of a magnetic core within the electromagnetic coil, wherein the first part is formed from a first material having a first magnetic performance;
defining a cavity with the first part; and
positioning a second part of the magnetic core at least partially within the cavity, wherein the second part is formed from a material having a second magnetic performance that is higher than the first magnetic performance.

Preferably, the first material further comprises a first corrosion resistance and wherein the second material comprises a second corrosion resistance that is less than the first corrosion resistance.
Preferably, the method further comprises a step of coupling a movable armature to the valve member.

Preferably, the method further comprises a step of positioning the movable armature at least partially within the electromagnetic coil.

Preferably, the step of positioning the first part of the magnetic core comprises a step of isolating the second part of the magnetic core from the inlet and outlet ports.

Preferably, the first material comprises ferritic stainless steel.

Preferably, the second material comprises soft iron.

### BRIEF DESCRIPTION OF THE DRAWINGS

FIG. 1 shows a cross-sectional view of a prior art solenoid valve.

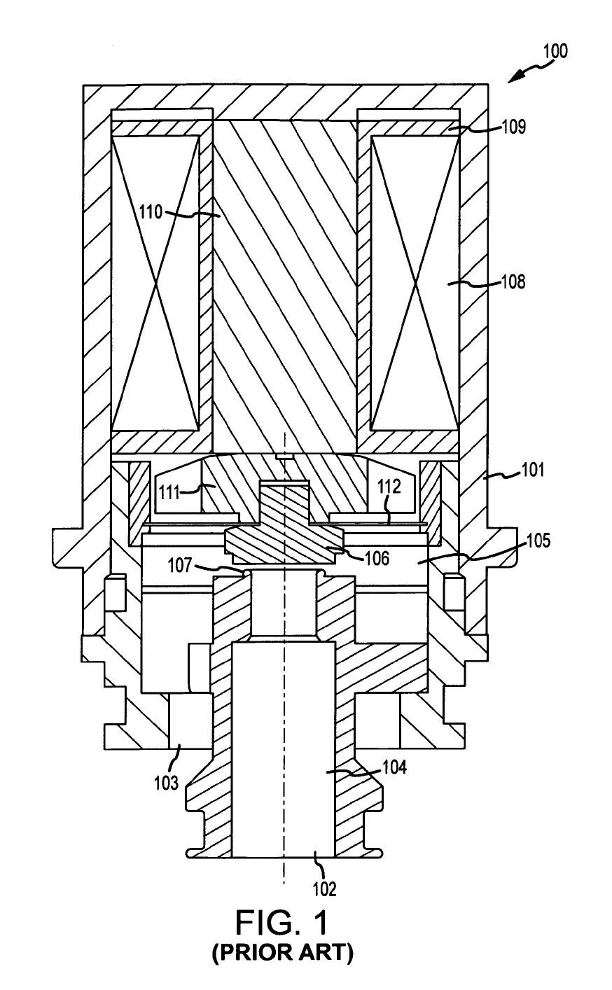

FIG. 2 shows a cross-sectional view of a solenoid valve according to an embodiment of the invention.

FIG. 3 shows a cross-sectional view of the solenoid valve according to another embodiment of the invention.

FIG. 4 shows a graph of a B-H curve for the first and second materials used to form the present invention.

### DETAILED DESCRIPTION OF THE INVENTION

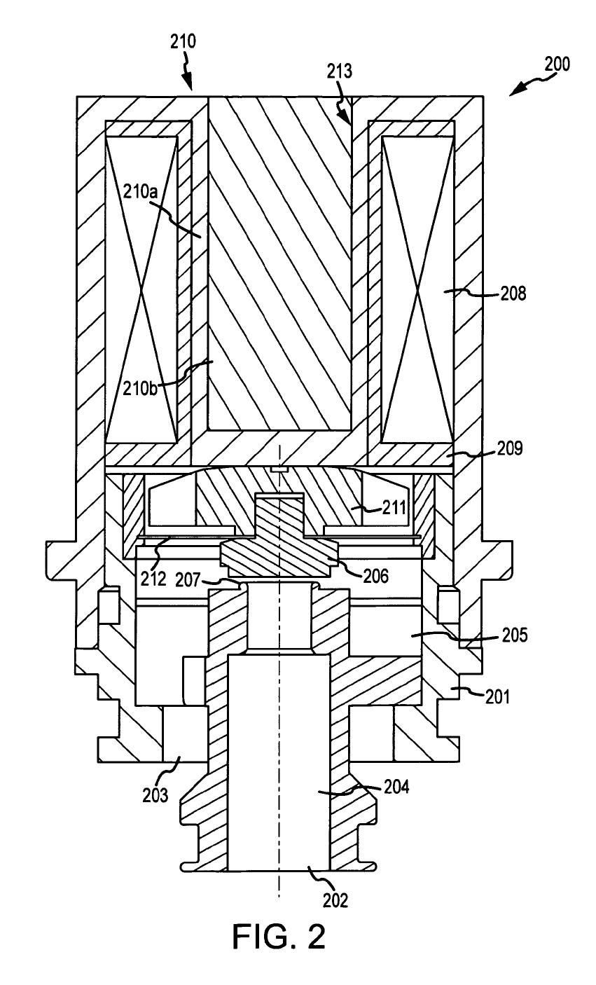

FIGS. 2-4 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 shows a cross-sectional view of a solenoid valve 200 according to an embodiment of the invention. While the description that follows is directed towards a normally closed valve 200, those skilled in the art will readily appreciate how to modify the valve to comprise a normally open valve. Therefore, the present invention should not be limited to a normally closed valve. The solenoid valve 200 comprises a housing 201, a first fluid port 202, a second fluid port 203, a fluid nozzle 204, a fluid chamber 205, a valve member 206, and a valve seat 207. According to an embodiment of the invention, the valve member 206 is coupled to a movable armature 211. A biasing member 212 is provided that biases the movable armature 211 and the valve member 206 in a first direction. The biasing member 212 is shown as comprising a plate spring; however, other biasing members can certainly be used while remaining within the scope of the present invention. The plate spring 212 may be pre-stressed in order to provide the biasing force that acts on the valve member 206 and the movable armature 211. It should be appreciated that the valve member 206 and the movable member 211 may be biased in the first direction according to other means, such as a pilot fluid, for example. Therefore, the present invention should not be limited to requiring a biasing member 212. According to an embodiment of the invention, the first fluid port 202 comprises an inlet port while the second fluid port 203 comprises an outlet port. However, it should be appreciated that the fluid flow through the valve 200 could be reversed. It should further be appreciated that the valve 200 may comprise more than two fluid ports. Therefore, the particular embodiment shown in the figures should in no way limit the scope of the present invention.

The valve 200 shown in FIG. 2 also includes an electromagnetic coil 208 located within a sleeve 209 (coil bobbin). The electromagnetic coil 208 may comprise a typical electromagnetic coil as is generally provided in solenoid valves. According to an embodiment of the invention, the electromagnetic coil 208 surrounds at least a portion of a magnetic core 210. According to an embodiment of the invention, the magnetic core 210 comprises a first part 210a and a second part 210b. According to an embodiment of the invention, the first part 210a defines a cavity 213. The cavity 213 can be adapted to receive at least a portion of the second part 210b. In the embodiment shown, the second part 210b is positioned within the cavity 213 formed by the first part 210a. According to an embodiment of the invention, the cavity 213 can be provided to surround the second part 210b on two or more sides. According to the embodiment shown, the cavity 213 of the first part 210a surrounds the second part 210b such that the second part 210b is substantially isolated from the movable armature 211 as well as the fluid flowing through the valve 200. Advantageously, the second part 210b is substantially protected from the potentially corrosive fluid flowing through the valve 200. The second part 210b may be retained within the cavity 213 according to known methods including, welding, brazing, bonding, adhesives, shrink fit, mechanical fasteners, etc. The particular method used to hold the second part 210b should not limit the scope of the present invention. The cavity 213 also allows the second part 210b to be formed into a substantially regular shaped component, such as a cylinder, for example. Advantageously, manufacturing of the second part 210b can be simplified. This may be desirable in situations where the second part 210b is formed from a brittle material or a material that is otherwise difficult to machine into complex shapes.

According to an embodiment of the invention, the first and second parts 210a, 210b are formed from different materials. The first material used to form the first part 210a may comprise a material having a first magnetic performance. The second material used to form the second part 210b may comprise a material having a second magnetic performance. According to an embodiment of the invention, the second magnetic performance is higher than the first magnetic performance of the first material. The magnetic performances of the first and second materials may vary due to differing magnetic characteristics. For example, the magnetic performance of the second material may be higher than the magnetic performance of the first material due to a higher magnetic permeability (μ), a greater magnetic saturation, a lower magnetic coercivity, or a combination thereof. According to an embodiment of the invention, the first material may also have a first resistance to corrosion. The resistance to corrosion may be a resistance to corrosion caused by the environment or the fluid flowing through the valve 200. However, according to an embodiment of the invention, the second material has a second corrosion resistance, which is lower than the first corrosion resistance. Therefore, as can be appreciated, while the first part 210a can contact the fluid flowing through the valve 200 due to the higher corrosion resistance, the first part 210a does not provide a high magnetic performance. Therefore, use of only the first part 210a of the magnetic core 210 restricts the performance of the valve 200. In contrast, while the second part 210b provides superior magnetic performance compared to the first part 210a, the second part 210b is more susceptible to corrosion and therefore, should not contact the fluid. Therefore, use of the second part 210b alone would result in excessive corrosion and premature failure of the valve 200. By utilizing a magnetic core 210 formed from the two parts 210a, 210b, the magnetic core 210 can benefit from the advantages provided by both materials. The first part 210a can provide the required corrosion resistance, mechanical properties, ease of fabrication, low cost, etc. necessary for a magnetic core. The second part 210b can advantageously increase the magnetic flux of the valve 200 without increasing the size of the valve 200 and/or increasing the electrical current provided to the valve 200. An increased magnetic flux results in a larger force being applied to the movable armature 211 during actuation of the valve 200.

According to an embodiment of the invention, the first material can comprise a ferritic stainless steel. According to an embodiment of the invention, the second material can comprise a soft iron having a higher magnetic performance compared to the ferritic stainless steel used for the first material. Soft irons provide the advantage of being highly magnetized when a magnetic field is induced yet they do not remain magnetized when the field is removed. The soft iron may comprise an iron-cobalt alloy, an iron-silicon alloy, an iron-nickel alloy, etc. In other embodiments, the first material may comprise a non-magnetic material. This configuration may be possible if the size and/or the magnetic performance of the second part 210b is large enough to compensate for the lack in magnetic properties of the first part 210a. It should be appreciated that the above-mentioned materials are merely examples of suitable materials that can be used for each of the parts of the magnetic core 210. Therefore, the examples provided should in no way limit the scope of the present invention. Rather, those skilled in the art will readily recognize suitable alternatives to the provided examples.

It should be appreciated that while the magnetic core 210 is shown positioned around a portion of the electromagnetic coil 208, in other embodiments, the magnetic core 210 can be positioned within the coil 208 without surrounding a portion of the coil 208.

As can be appreciated, with the magnetic core 210 comprising the first and the second part 210a, 210b, the magnetic flux produced by the valve 200 is substantially increased without increasing the size of the electromagnetic coil 208 or the electrical current supplied to the electromagnetic coil 208. With an improved magnetic flux, the valve 200 can be utilized in environments with increased fluid flow rates/fluid pressures.

In use, power can be supplied to the electromagnetic coil 208 as is generally known in the art. With power supplied to the coil 208, a magnetic flux is provided that is directed through the magnetic core 210 in order to actuate the movable armature 211 and thus, the valve member 206. Because the valve 200 is shown as a normally closed valve, the actuation of the movable armature 211 moves the movable armature 211 away from the valve seat 207. In embodiments where the valve 200 comprises a normally closed valve, the biasing member 212 provides a biasing force to bias the movable armature 211 and the valve member 206 against the valve seat 207 to close the valve 200. Therefore, when power is supplied to the electromagnetic coil 208, the magnetic flux provided by the coil 208 is directed through the magnetic core 210 and pulls the movable armature 211 up to open a fluid communication path between the fluid inlet 202 and the fluid outlet 203. With the valve member 206 moved away from the valve seat 207, fluid can flow from the fluid inlet 202, through the fluid nozzle 204 and into the fluid chamber 205 where the fluid is then directed out of the valve 200 through the fluid outlet 203.

It should be appreciated that the power provided to the electromagnetic coil 208 can be varied in order to adjust the magnetic flux produced and thus, the size of the opening provided between the valve member 206 and the valve seat 207.

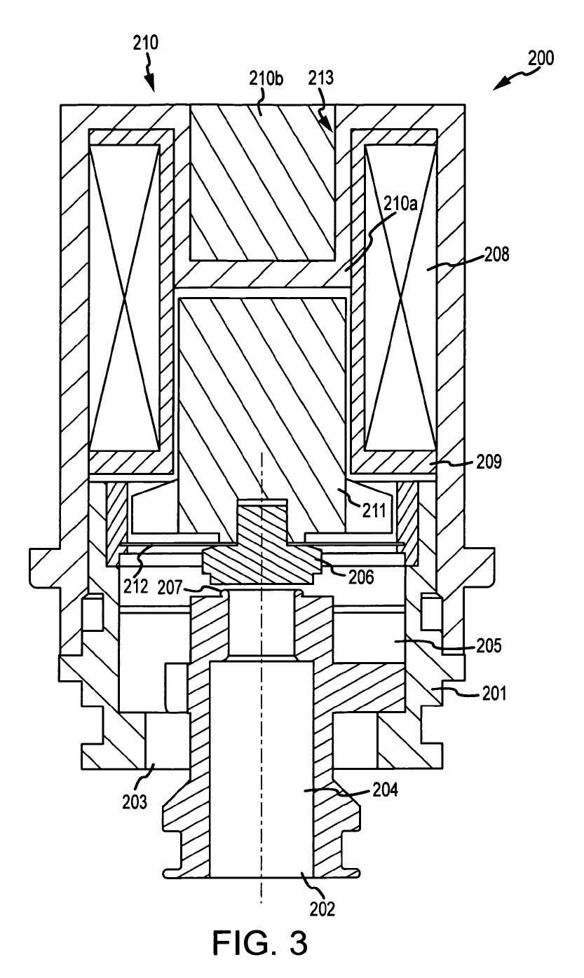

According to the embodiment shown in FIG. 2, the magnetic core 210 is positioned substantially within the electromagnetic coil 208 with the movable armature 211 positioned below the electromagnetic coil 208. It should be appreciated that in other embodiments, the movable armature 211 may extend within the electromagnetic coil 208 as shown in FIG. 3.

FIG. 3 shows a cross-sectional view of the solenoid valve 200 according to another embodiment of the invention. In the embodiment shown in FIG. 3, the movable armature 211 extends within the electromagnetic coil 208. Consequently, the size of the magnetic core 210 is reduced. However, with a portion of the movable armature 211 positioned within the coil 208, a weaker magnetic flux can provide the same attraction force provided by the configuration shown in FIG. 2 because the movable armature 211 is positioned where the magnetic flux is the strongest. As can be appreciated, providing a magnetic core with a reduced size configuration was difficult in the prior art due to the lower magnetic performance of the magnetic core.

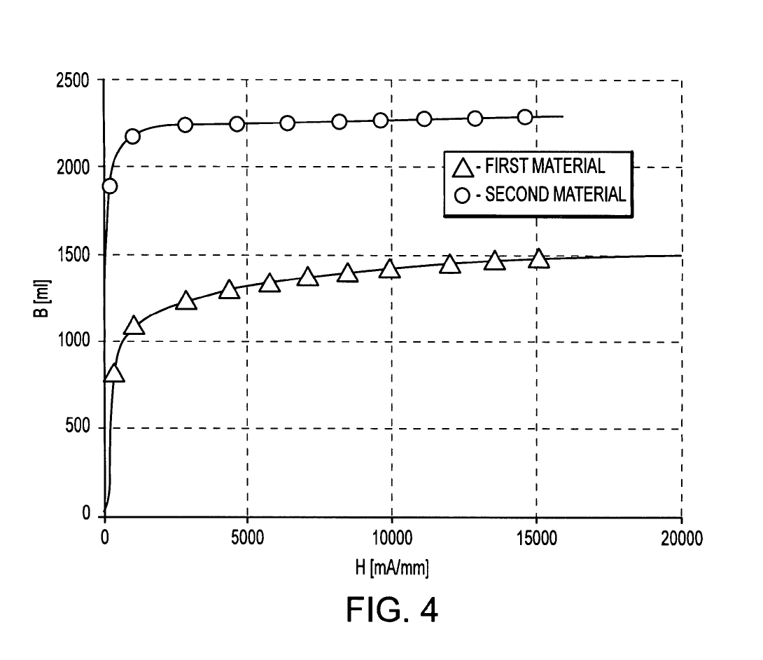

FIG. 4 shows a graph of magnetic flux density versus magnetic field for the first and second materials used in the present invention. As shown, for a given magnetic field, the magnetic flux density is substantially higher for the second material than for the first material. This is due to the superior magnetic performance of the second material. Advantageously, the second material provides a higher magnetic flux density without requiring a corresponding increase in the electrical current supplied to the electromagnetic coil 208. This results in a higher magnetic force acting on the movable armature 211.

As described above, the present invention provides a solenoid valve with a two-part core. The solenoid valve of the present invention advantageously improves the magnetic flux produced by the valve while maintaining suitable corrosion protection, mechanical properties, ease of manufacturing, etc. By positioning the second part of the magnetic core within a cavity defined by the first part, the second part is substantially protected from corrosion. Therefore, materials with high magnetic performance that were previously unsuitable for use in solenoid valves due to the high tendency to easily corrode and/or difficulty in manufacturing can be used with the present invention.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other valves, and not just to the embodiments described above and shown in the accompanying figures. Accordingly, the scope of the invention should be determined from the following claims.

We claim:

1. A magnetic core (210) for a solenoid valve, comprising:
a first part (210a) defining a cavity (213) and being formed from a first material having a first magnetic performance; and
a second part (210b) positioned at least partially within the cavity (213) and being formed from a second material having a second magnetic performance that is higher than the first magnetic performance.

2. The magnetic core (210) of claim 1, wherein the first material further comprises a first corrosion resistance and wherein the second material comprises a second corrosion resistance that is less than the first corrosion resistance.

3. The magnetic core (210) of claim 1, wherein the first material comprises ferritic stainless steel.

4. The magnetic core (210) of claim 1, wherein the second material comprises soft iron.

5. A solenoid valve (200), comprising:
an inlet port (202);
an outlet port (203);
a valve member (206) selectively providing fluid communication between the inlet port (202) and the outlet port (203);
an electromagnetic coil (208) providing a biasing force on the valve member (206) when energized;
a magnetic core (210) positioned within the electromagnetic coil (208) and including:
a first part (210a) defining a cavity (213) and being formed from a first material having a first magnetic performance; and
a second part (210b) positioned at least partially within the cavity (213) and being formed from a second material having a second magnetic performance that is higher than the first magnetic performance.

6. The solenoid valve (200) of claim 5, wherein the first material further comprises a first corrosion resistance and wherein the second material comprises a second corrosion resistance that is less than the first corrosion resistance.

7. The solenoid valve (200) of claim 5, further comprising a movable armature (211) coupled to the valve member (206).

8. The solenoid valve (200) of claim 7, wherein the movable armature (211) is positioned at least partially within the electromagnetic coil (208).

9. The solenoid valve (200) of claim 5, wherein the first part (210a) of the magnetic core (210) isolates the second part (210b) from the inlet and outlet ports (202, 203).

10. The solenoid valve (200) of claim 5, wherein the first material comprises ferritic stainless steel.

11. The solenoid valve (200) of claim 5, wherein the second material comprises soft iron.

12. A method for forming a solenoid valve including an inlet port, an outlet port, and a valve member selectively providing fluid communication between the inlet port and the outlet port, comprising steps of:
positioning an electromagnetic coil proximate the valve member to provide a biasing force on the valve member when energized;
positioning a first part of a magnetic core within the electromagnetic coil, wherein the first part is formed from a first material having a first magnetic performance;
defining a cavity with the first part; and
positioning a second part of the magnetic core at least partially within the cavity, wherein the second part is formed from a material having a second magnetic performance that is higher than the first magnetic performance.

13. The method of claim 12, wherein the first material further comprises a first corrosion resistance and wherein the second material comprises a second corrosion resistance that is less than the first corrosion resistance.

14. The method of claim 12, further comprising a step of coupling a movable armature to the valve member.

15. The method of claim 14, further comprising a step of positioning the movable armature at least partially within the electromagnetic coil.

16. The method of claim 12, wherein the step of positioning the first part of the magnetic core comprises a step of isolating the second part of the magnetic core from the inlet and outlet ports.

17. The method of claim 12, wherein the first material comprises ferritic stainless steel.

18. The method of claim 12, wherein the second material comprises soft iron.
